(19) United States
(12) Patent Application Publication
(10) Pub. No.: US 2026/0178140 A1
(43) Pub. Date: Jun. 25, 2026

(54) ROLLER MODULE AND MOUSE APPARATUS THEREOF

(71) Applicant: DARFON ELECTRONICS CORP., Taoyuan City (TW)

(72) Inventors: Cheng-Wei Fu, Taoyuan City (TW); Chen-Yun Su, Taoyuan City (TW)

(73) Assignee: DARFON ELECTRONICS CORP., Taoyuan City (TW)

(21) Appl. No.: 19/399,696

(22) Filed: Nov. 25, 2025

(30) Foreign Application Priority Data
Dec. 19, 2024 (TW) 113149548

(51) Int. Cl. G06F 3/0362; G06F 3/0354; G06F 3/038

(52) U.S. Cl. CPC G06F 3/0362; G06F 3/03543; G06F 3/0383

(57) ABSTRACT

A roller module is used for an input device and includes a roller bracket, a roller, a motor, a rotation sensor and a control circuit board. The roller is rotatably disposed on the roller bracket. The motor is connected to the roller for driving the roller to rotate. The rotation sensor is disposed on at least one side of the roller for detecting a rotation direction of the roller when the roller is rotated by an external force. The control circuit board is electrically connected to the motor and the rotation sensor. The control circuit board outputs a reverse rotation signal to the motor according to the rotation direction detected by the rotation sensor for driving the motor to exert a reverse rotation torque to the roller within a specific period of time.

### BACKGROUND OF THE INVENTION

### 1. FIELD OF THE INVENTION

The present invention relates to a roller module and a mouse apparatus thereof, and more specifically, to a roller module driving a motor to rotate reversely according to a rotation direction of a roller detected by a rotation sensor and a mouse apparatus thereof.

### 2. DESCRIPTION OF THE PRIOR ART

With the advancement and development of technology, computers have been widely applied in daily life. For a personal computer, a mouse apparatus is one of necessary input devices. For example, a user could perform a corresponding input operation, such as scrolling a webpage, by rotating a roller of the mouse apparatus (e.g., rotating the roller by the user’s finger). In the prior art, a rotation sensor and a processor are disposed inside the mouse apparatus. The rotation sensor is used to detect rotation of the roller, while the processor enables the rotation sensor to continuously detect the rotation of the roller. Once the rotation sensor detects any rotation of the roller, the processor transmits a signal relating to a rotation angle of the roller to the personal computer, so that the personal computer can appropriately scrolls the webpage or document according the rotation angle of the roller.

In practical applications, in order to allow the user to effectively control the rotation angle of the roller, a resistance mechanism is generally disposed inside the mouse apparatus to provide a tactile feedback as the user rotates the roller. The user can sense the changes in resistance through the finger, thereby precisely controlling an actual rotation angle of the roller. A conventional resistance mechanical design involves generating a tactile feedback via interference between internal components of the mouse apparatus. However, after a period of use, this resistance mechanical design causes wear between the internal components due to frequent contact and interference, so as to make the resistance mechanism fail to generate the tactile feedback. In addition, the numerous internal components for generating resistance lead to a complicated resistance mechanical design and occupy too much internal space of the mouse apparatus, thus affecting flexibility of the internal component configuration within the mouse apparatus and being disadvantageous to the thinning design of the mouse apparatus.

### SUMMARY OF THE INVENTION

The present invention provides a roller module for an input device. The roller module includes a roller bracket, a roller, a motor, a rotation sensor and a control circuit board. The roller is rotatably disposed on the roller bracket. The motor is connected to the roller to drive the roller to rotate. The rotation sensor is disposed on at least one side of the roller for detecting a rotation direction of the roller when the roller is rotated by an external force. The control circuit board is electrically connected to the motor and the rotation sensor. The control circuit board outputs a reverse rotation signal to the motor according to the rotation direction detected by the rotation sensor, for driving the motor to exert a reverse rotation torque to the roller within a specific period of time.

The present invention further provides a mouse apparatus including a mouse body and a roller module. The mouse body has an opening formed thereon. The roller module is disposed in the mouse body. The roller module includes a roller bracket, a roller, a motor, a rotation sensor, and a control circuit board. The roller is rotatably disposed on the roller bracket and protrudes outward from the opening. The motor is connected to the roller to drive the roller to rotate. The rotation sensor is disposed on at least one side of the roller for detecting a rotation direction of the roller when the roller is rotated by an external force. The control circuit board is electrically connected to the motor and the rotation sensor. The control circuit board outputs a reverse rotation signal to the motor according to the rotation direction detected by the rotation sensor, for driving the motor to exert a reverse rotation torque to the roller within a specific period of time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a mouse apparatus according to an embodiment of the present invention.

FIG. 2 is a diagram of a roller module in FIG. 1.

FIG. 3 is a functional block diagram of the roller module in FIG. 2.

FIG. 4 is a flowchart of a control circuit board driving a motor to rotate reversely according to a rotation direction of a roller detected by a rotation sensor.

### DETAILED DESCRIPTION

The present invention will now be described more specifically with reference to the following embodiments and the accompanying drawings. Other advantages and effects of the present invention can be easily understood by a person ordinarily skilled in the art in view of the detailed descriptions and the accompanying drawings. The present invention can be implemented or applied to other different embodiments. Certain aspects of the present invention are not limited by the particular details of the examples illustrated herein. Without departing from the spirit and scope of the present invention, the present invention will have other modifications and changes. It should be understood that the appended drawings are not necessarily drawn to the scale and configuration of each component (e.g., an outer appearance design of a mouse apparatus) in the drawings is merely illustrative, not presenting an actual condition of the embodiments.

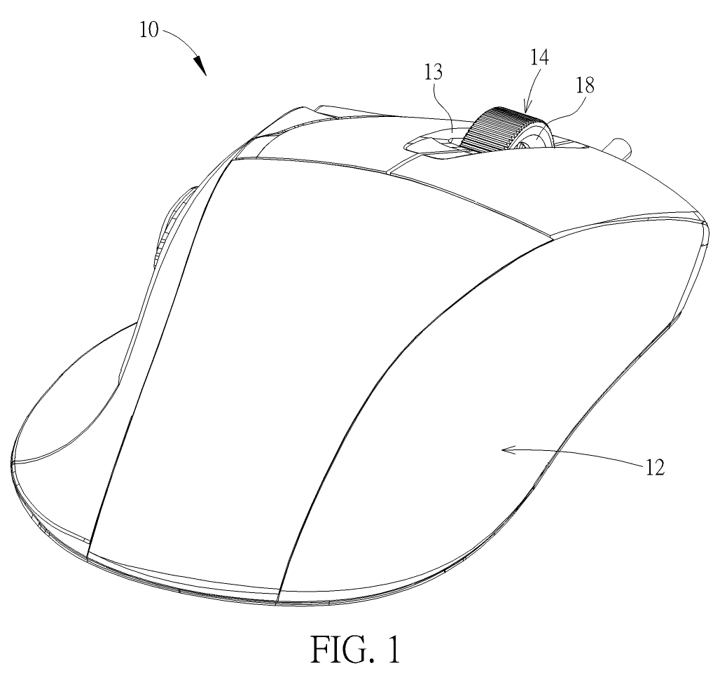

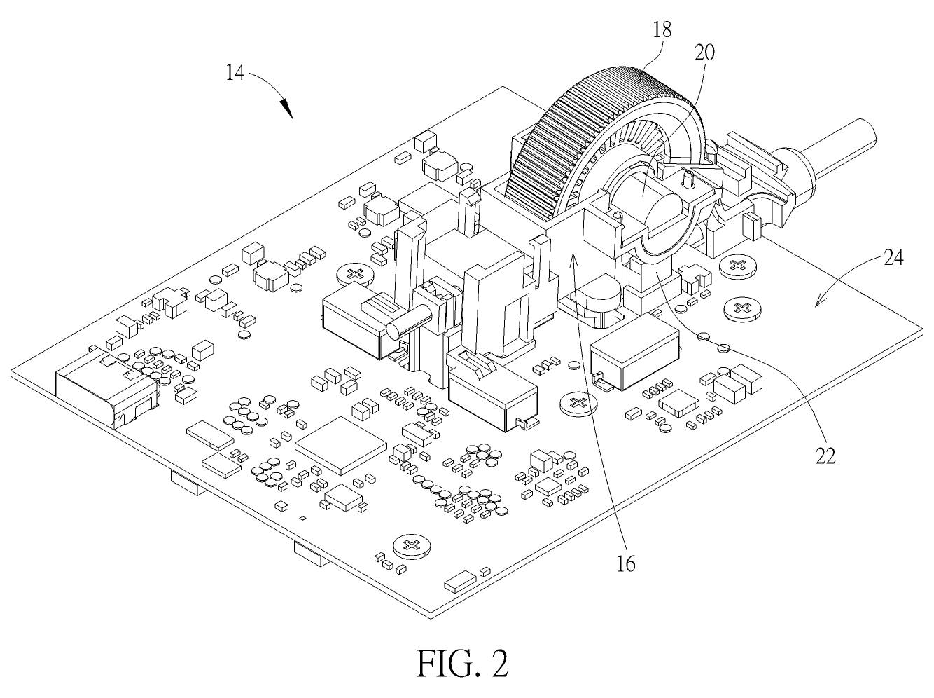

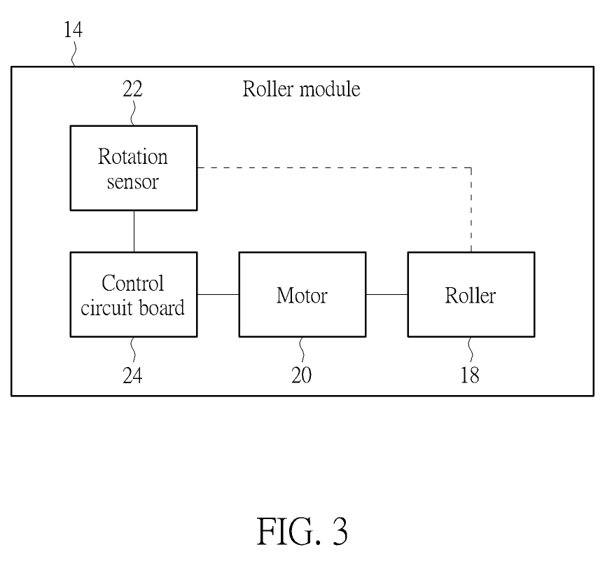

Please refer to FIG. 1, FIG. 2, and FIG. 3. FIG. 1 is a diagram of a mouse apparatus 10 according to an embodiment of the present invention. FIG. 2 is a diagram of a roller module 14 in FIG. 1. FIG. 3 is a functional block diagram of the roller module 14 in FIG. 2. The roller module design provided by the present invention could be preferably applied to a mouse apparatus (but not limited thereto, meaning that the present invention could be applied to other common input devices, such as a keyboard, a drawing tablet, or a game controller) for allowing a user to perform a rolling input operation. As shown in FIGS. 1-3, the mouse apparatus 10 includes a mouse body 12 and the roller module 14. The mouse body 12 has an opening 13 to provide space for roller protrusion. The mouse body 12 could include common mouse components, such as mouse buttons and a mouse casing, and the related description is omitted herein since it is commonly seen in the prior art.

The roller module 14 is disposed within the mouse body 12 and includes a roller bracket 16, a roller 18, a motor 20, a rotation sensor 22, and a control circuit board 24. The roller 18 is rotatably disposed on the roller bracket 16 and protrudes outward from the opening 13 to allow the user to perform a forward and backward rotation operation (e.g., moving a vertical scroll bar of a window interface upward and downward) by pushing the roller 18 with a finger. The motor 20 could be preferably a brushless direct current (DC) motor (but not limited thereto) and is connected to the roller 18 to drive the roller 18 to rotate, thereby providing a reverse rotation torque to the roller 18 to generate a tactile feedback. In this embodiment, an output shaft of the motor 20 could be directly fixed to a center of the roller 18, such as a hub of the roller 18, but the present invention is not limited thereto. For example, the motor 20 could be coupled to the roller 18 via a transmission mechanism, such as a gear set or a belt transmission mechanism, or alternatively, the motor 20 could be coupled to a rim of the roller 18 (e.g., via a ring gear and a pinion). The rotation sensor 22 could be a sensing device commonly used to detect a rotation direction of a roller when the roller is rotated by an external force. The rotation sensor 22 is disposed on at least one side of the roller 18 (only one side shown in FIG. 2, but not limited thereto, meaning that the placement of the rotation sensor 22 depends on the sensing method adopted by the rotation sensor 22). For example, the rotation sensor 22 could be a mechanical encoder, which detects the rotation direction of the roller 18 according to rotation of a mechanical encoder disk driven by the roller 18. In some embodiments, the rotation sensor 22 could be an optical encoder, which detects the rotation direction of the roller 18 via interruption and transmission of light signals caused by a grating structure of the roller 18 during rotation of the roller 18. In some embodiments, the rotation sensor 22 could be a Hall sensor (or other magnetic sensing device), which detects the rotation direction of the roller 18 by sensing magnetic field changes of a magnetic component on the roller 18 during rotation of the roller 18. As for which sensing method is adopted, it depends on the actual manufacturing and application requirements of the present invention. The control circuit board 24 could be a circuit board commonly used for mouse signal transmission and control (the related description is commonly seen in the prior art and omitted herein) and is electrically connected to the motor 20 and the rotation sensor 22 (as shown in FIG. 3) to drive the motor 20 to rotate reversely according to the rotation direction of the roller 18 detected by the rotation sensor 22.

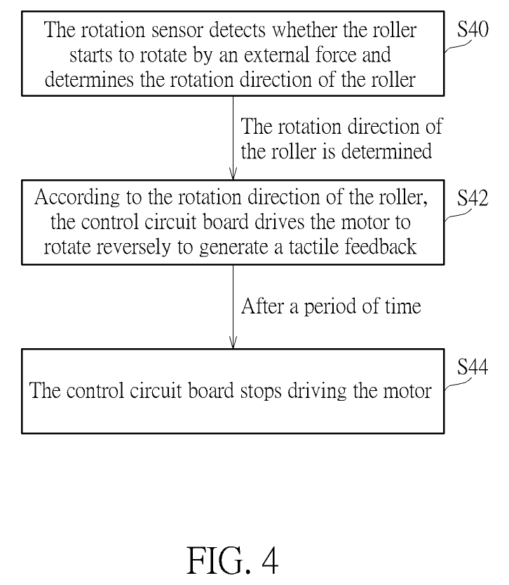

Via the aforesaid design, when the user performs a forward and backward rotation operation (e.g., moving a vertical scroll bar of a window interface upward and downward) by pushing the roller 18 with a finger, the rotation sensor 22 can instantly detect the rotation direction of the roller 18 and transmit a detection result to the control circuit board 24. Accordingly, the control circuit board 24 can, based on the detection result generated by the rotation sensor 22, output a reverse rotation signal to the motor 20 during rotation of the roller 18, to drive the motor 20 to apply a reverse rotation torque to the roller 18 within a specific period of time (preferably between 1ms and 5ms, but not limited thereto, meaning that the driving duration could be adjusted according to user operation requirements to generate different tactile feedbacks), thereby instantly generating a tactile feedback. As a result, the user can perceive the change of resistance during the rotation of the roller 18 via the tactile feedback and thus precisely control an actual rotation angle of the roller 18. For example, please refer to FIG. 4, which is a flowchart of the control circuit board 24 driving the motor 20 to rotate reversely according to the rotation direction of the roller 18 detected by the rotation sensor 22. As shown in FIG. 4, first, in step S40, the rotation sensor 22 detects whether the roller 18 starts to rotate by an external force and determines the rotation direction of the roller 18. In brief, assuming the rotation sensor 22 is configured as a mechanical encoder, when the user pushes the roller 18 to rotate forward, the rotation sensor 22 could receive a 0-1 or 1-0 signal and determine that the roller 18 rotates forward. On the other hand, when the user pushes the roller 18 to rotate backward, the rotation sensor 22 could receive a 1-1 or 0-0 signal and determine that the roller 18 rotates backward. After completing the above step of determining the rotation direction (step S40), in step S42, according to the corresponding 0-1 or 1-0 signal for a forward rotation of the roller 18, the control circuit board 24 drives the motor 20 to momentarily rotate backward to cause the roller 18 to generate a backward tactile feedback, or, according to the corresponding 1-1 or 0-0 signal for a backward rotation of the roller 18, the control circuit board 24 drives the motor 20 to momentarily rotate forward to cause the roller 18 to generate a forward tactile feedback. Finally, after a period of time (e.g., 1ms~5ms), the control circuit board 24 stops driving the motor 20 (step S44), thereby completing the process of the roller module 14 providing the tactile feedback.

In summary, compared with the prior art adopting the resistance mechanical design of generating the tactile feedback via the interference between the internal components of the mouse apparatus, the roller module of the present invention adopts the aforesaid electromechanical control design in which the motor is reversely rotated according to the rotation direction detected by the rotation sensor, so as to precisely and instantly provide the tactile feedback during the user’s finger operation for the roller. In such a manner, the present invention not only improves the input accuracy and tactile feedback of the roller, but also effectively solves the prior art problem that the resistance mechanism fails to generate the tactile feedback due to wear between the internal components and the complicated resistance mechanical design occupies much internal space of the mouse apparatus. Thus, the present invention can greatly enhance flexibility of the internal component configuration within the mouse apparatus and be advantageous to the thinning design of the mouse apparatus.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A roller module for an input device, the roller module comprising:
a roller bracket;
a roller rotatably disposed on the roller bracket;
a motor connected to the roller to drive the roller to rotate;
a rotation sensor disposed on at least one side of the roller for detecting a rotation direction of the roller when the roller is rotated by an external force; and
a control circuit board electrically connected to the motor and the rotation sensor, the control circuit board outputting a reverse rotation signal to the motor according to the rotation direction detected by the rotation sensor, for driving the motor to exert a reverse rotation torque to the roller within a specific period of time.

2. The roller module of claim 1, wherein the specific period of time is between 1ms and 5ms.

3. The roller module of claim 1, wherein the rotation sensor is a Hall sensor, an optical encoder, or a mechanical encoder.

4. The roller module of claim 1, wherein the motor is a brushless direct-current (DC) motor.

5. A mouse apparatus comprising:
a mouse body having an opening formed thereon; and
a roller module disposed in the mouse body, the roller module comprising:
a roller bracket;
a roller rotatably disposed on the roller bracket and protruding outward from the opening;
a motor connected to the roller to drive the roller to rotate;
a rotation sensor disposed on at least one side of the roller for detecting a rotation direction of the roller when the roller is rotated by an external force; and
a control circuit board electrically connected to the motor and the rotation sensor, the control circuit board outputting a reverse rotation signal to the motor according to the rotation direction detected by the rotation sensor, for driving the motor to exert a reverse rotation torque to the roller within a specific period of time.

6. The mouse apparatus of claim 5, wherein the specific period of time is between 1ms and 5ms.

7. The mouse apparatus of claim 5, wherein the rotation sensor is a Hall sensor, an optical encoder, or a mechanical encoder.

8. The mouse apparatus of claim 5, wherein the motor is a brushless direct-current motor.
